(19) United States
(12) Patent Application Publication
(10) Pub. No.: US 2014/0359366 A1
(43) Pub. Date: Dec. 4, 2014

(54) Method and Engineering Apparatus for Performing a Three-Dimensional Analysis of a Technical System

(71) Applicants: Jean-Pascal Schwinn, Munchen (DE); Sanja Uzelac, Geiselbullach/Olching (DE)

(72) Inventors: Jean-Pascal Schwinn, Munchen (DE); Sanja Uzelac, Geiselbullach/Olching (DE)

(21) Appl. No.: 13/925,751

(22) Filed: Jun. 24, 2013

(30) Foreign Application Priority Data
May 28, 2013 (EP) 13169503

(51) Int. Cl. G06F 11/26

(52) U.S. Cl. CPC G06F 11/26
USPC 714/37

(57) ABSTRACT

A method for performing a three-dimensional analysis of an investigated technical system represented by a corresponding fault tree is provided. The method includes linking basic events logically to a top event of the investigated system. The fault tree is a three-dimensional fault tree. Each event of the fault tree is represented by a three-dimensional body having projection surfaces adapted to output analysis data of the respective event to a user.

This application claims the benefit of EP 13169503, filed on May 28, 2013, which is hereby incorporated by reference.

### BACKGROUND

The present embodiments relate to a method and apparatus for performing a three-dimensional analysis of a complex investigated technical system including technical components. With increasing complexity of technical systems, computer-implemented tools and analyzing methods are used. Already in the first stages of product developments, questions concerning security, reliability, availability, and performance that are relevant for the architecture and implementation of the respective technical system arise.

Reliability and safety engineering is an engineering discipline to assure that the engineered system provides acceptable levels of safety and reliability. Safety engineering provides that a critical system behaves as required even when components of the technical system fail. The goal of safety engineering is to manage risk and to eliminate or at least reduce the risk to acceptable levels. Safety and reliability engineering may employ different analysis techniques such as fault tree analysis (FTA). FTA is a top-down deductive analytical method used in safety and reliability engineering of technical systems. Fault tree analysis initiating basic events and external events may be traced through intermediate events performing logic combinations to an undesired top event. Typical top events may be, for example, a total loss of production of a production facility, the unavailability of a safety system, a toxic emission, an aircraft crash or even a nuclear reactor core melt. Basic events at the bottom of the fault tree may represent component and human faults, for which statistical failure and repair data is available. Typical basic events in a fault tree may be, for example, a pump failure, a temperature controller failure or a not-responding operator. For an investigated technical system or subsystem, a corresponding fault tree may be generated. A top level event TLE includes a result that expresses the availability and reliability of the investigated technical system. The fault tree analysis FTA may be qualitative or quantitative. When failure and event probabilities are unknown, qualitative fault trees may be analyzed for minimal cut sets. For example, if any minimal cut set contains a single basic event, then the top level event may be caused by a single failure. In contrast, quantitative fault tree analysis is used to compute a top event probability calculated by a computer-implemented tool or computer program. Conventional fault trees used by engineering tools are two-dimensional and have a simple tree structure. In a complex technical system, where on each level of the fault tree, a plurality of heterogeneous evaluation results or data is available, the conventional fault trees may no longer provide efficient transparency of the interrelations between the events and corresponding components. Accordingly, conventional fault trees displayed to a user by the analyzing tool are not easy to understand for a user. Since a user becomes easily lost in the conventional fault tree, it becomes very difficult for the user to recognize relevant interrelations that may be used for planning a complex technical system. For example, an interactive and intuitive information request as well as editing or modeling a technical system in a two-dimensional fault tree is cumbersome and confusing.

### SUMMARY AND DESCRIPTION

The scope of the present invention is defined solely by the appended claims and is not affected to any degree by the statements within this summary.

There is a need for a method and apparatus that overcomes the above-mentioned disadvantages and provides the user with a high degree of transparency of an investigated technical system.

In a first aspect, a method for performing a three-dimensional analysis of an investigated technical system represented by a corresponding fault tree having basic events being linked logically to a top event of the investigated system is provided. The method includes outputting, by a three-dimensional body having projection surfaces representing each event of the fault tree, analysis data of the respective event to a user. The fault tree is a three-dimensional fault tree.

In one embodiment of the method, the fault tree of the investigated system includes a plurality of levels including a basic level of basic events linked logically via levels of intermediate events to a top level including the top event representing an undesired state of the investigated technical system.

In a further embodiment of the method, the levels of the fault tree are displayed in a nested display mode to the user as nested in one another. Each level is represented by a cubus being nested into another cubus representing the next higher level of the fault tree.

In yet another embodiment of the method, all levels of the fault tree are displayed in an unfolded display mode to a user as an unfolded three-dimensional tree of interlinked events.

In one embodiment of the method, the intermediate events perform a Boolean logic combination of events of a lower level of the fault tree.

In one embodiment of the method, the basic events of the fault tree represent faults including failure data.

In a further embodiment of the method, the events of the fault tree represent technical components of the investigated technical system.

In one embodiment of the method, the events of the fault tree of the investigated technical system displayed in the unfolded display mode to the user are displayed within a three-dimensional model of the respective investigated technical system.

In another embodiment of the method, the failure data of the basic events of the fault tree is provided at least partially by simulation data received from a data model of the investigated technical system.

In one embodiment of the method, the failure data of the basic events of the fault tree is provided at least partially by sensor data received from sensors deployed in the investigated technical system.

In one embodiment, an engineering apparatus adapted to perform a three-dimensional analysis of an investigated technical system includes a database that stores a constructed three-dimensional fault tree of the investigated technical system. The fault tree has basic events linked logically to a top event of the investigated technical system. Each event of the fault tree is represented by a three-dimensional body having projection surfaces each being adapted to display analysis data of the respective event calculated by a calculation unit of the engineering apparatus on the basis of the stored fault tree to a user.

In one embodiment of the engineering apparatus, the fault tree of the investigated technical system stored in the database includes several levels including a basic level of basic events linked logically via levels of intermediate events to a top level including the top event representing an undesired state of the investigated technical system.

According to another embodiment of the engineering apparatus, the levels of the fault tree are displayed in a nested display mode to the user as nested in one another. Each level is represented by a cubus being nested in another cubus representing the next higher level of the fault tree. Alternatively, all levels of the fault tree are displayed simultaneously in an unfolded display mode to a user as an unfolded three-dimensional tree of interlinked events.

In one embodiment of the engineering apparatus, the basic events of the fault tree represent faults including failure data. The failure data of the basic events of the fault tree is provided at least partially by simulation data received from a data model of the investigated technical system, or the failure data of the basic events of the fault tree is provided at least partially by sensor data received from sensors deployed in the investigated technical system.

In yet another embodiment of the engineering apparatus, the events of the fault tree of the investigated technical system displayed in the unfolded display mode to the user are displayed within a three-dimensional model of the respective investigated technical system.

In one embodiment, an engineering tool including a program code adapted to perform one or more embodiments of the method is provided. The engineering tool may include program code stored on a non-transitory computer readable storage medium. The program code may include instructions executable by one or more processors to perform the one or more embodiments of the method.

### BRIEF DESCRIPTION OF THE DRAWINGS

FIG. 1 shows a block diagram of one embodiment of an engineering apparatus;

FIG. 2 shows an exemplary displayed user interface of an engineering tool;

FIG. 3 shows a diagram of an exemplary three-dimensional fault tree displayed to a user in an unfolded display mode;

FIG. 4 shows a diagram for illustrating an exemplary display of a fault tree in a nested display mode;

FIG. 5 shows a diagram for illustrating exemplary output of analysis data to a user by projection surfaces of a three-dimensional body; and

FIG. 6 illustrates exemplary switching between different display modes.

### DETAILED DESCRIPTION

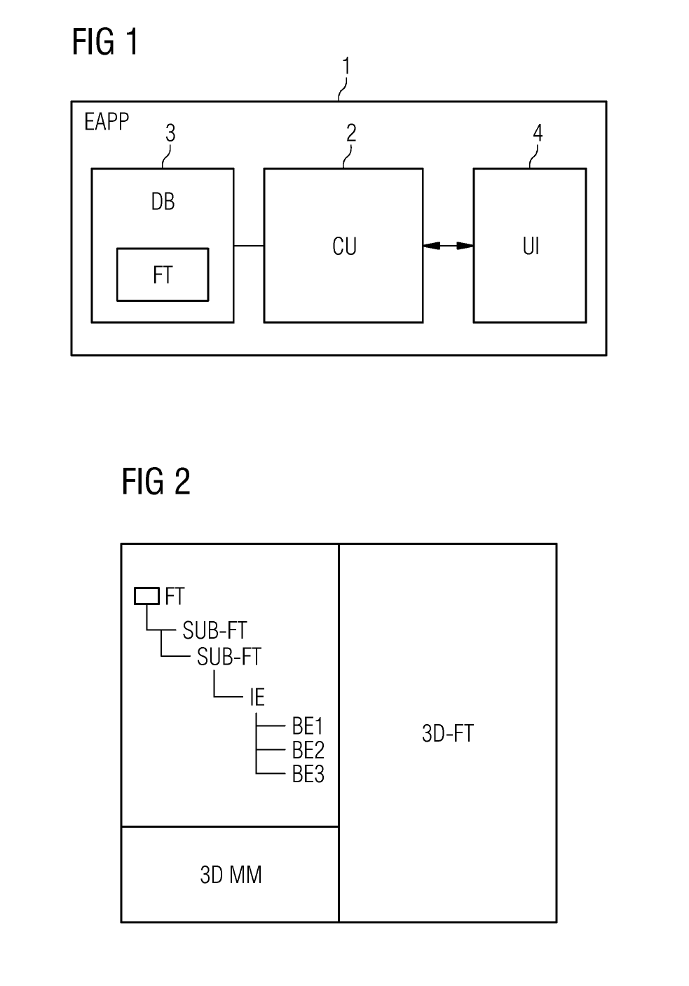

As shown in FIG. 1, an engineering apparatus 1 according to one or more embodiments and a calculation unit 2 including one or more microprocessors are connected to a database 3. The database 3 stores a constructed three-dimensional fault tree FT of an investigated technical system. The investigated technical system may be a complex technical system including a plurality of components (e.g., a vehicle such as a car or an aircraft, a power plant or a production facility). The three-dimensional fault tree FT stored in the database 3 includes basic events BE linked logically to a top event of the investigated technical system. The events of the fault tree FT may represent technical components or subsystems of the investigated technical system. The fault tree FT of the investigated system may include levels L including levels of basic events that are linked logically via levels of intermediate events to a top level event TE. The top level includes the top event TE representing an undesired state of the investigated technical system (e.g., a production loss of a manufacturing facility or a crash of a vehicle). Each event of the stored fault tree FT may be represented by a three-dimensional body having projection surfaces each being adapted to display analysis data of the respective event calculated by the calculation unit 2 of the engineering apparatus 1 on the basis of the stored fault tree FT to a user. The engineering apparatus 1 includes a user interface 4 having a display. The fault tree FT in one or more embodiments may be displayed by the engineering apparatus 1 to the user in different display modes.

In one or more embodiments of the engineering apparatus 1, the fault tree FT may be displayed in a nested display mode or in an unfolded display mode. In the nested display mode, the levels of the fault tree FT are displayed to the user as nested in one another. Each level L of the fault tree FT is represented by a cubus being nested into another cubus representing a next level of the respective fault tree FT. In contrast, in the unfolded display mode, all levels L of the fault tree FT are displayed to the user as an unfolded three-dimensional tree of interlinked events. In one implementation, the display modes may be selected by the user.

The basic events BE of the stored fault tree FT represent faults that may include failure data. In one embodiment, the failure data of the basic events BE of the fault tree FT is provided at least partially by simulation data that may be received from a data model of the investigated technical system. In another embodiment, the failure data of the basic events of the fault tree FT may be provided at least partially by sensor data received from sensors deployed in a prototype of the investigated technical system. In one embodiment, the failure data of the basic events may be input by the user via the user interface 4 of the engineering apparatus 1. In one embodiment of the engineering apparatus 1 as shown in FIG. 1, the events of the fault tree FT of the investigated technical system displayed in the unfolded display mode to the user are displayed within a three-dimensional technical model of the investigated system (e.g., in a computer-aided design (CAD) model of the respective technical system). This allows a more intuitive operation and processing of the engineering tool by the user.

With the method and apparatus according to one or more of the embodiments, each event of the fault tree FT displayed to the user may be represented by a three-dimensional body that has projection surfaces adapted to output analysis data of the respective event to the user. The analysis data displayed to the user by the projection surfaces may include different types of data including, for example, function diagrams, data spreadsheets, data tables, reliability data, safety data, statistical data and any kind of data relevant for the respective event represented by the three-dimensional body having the projection surfaces. The three-dimensional body representing an event may, for example, include a cubus, a conus or balls each with several projection surfaces. For example, a cubus includes six different possible projection surfaces to display analysis data to the user. Different type of bodies may be used for different types of events. For example, the basic events BE may be represented by spherical balls, whereas the intermediate event IE may be represented by a cubus. The intermediate events IE may, in one embodiment, perform a Boolean logic combination of events of a lower level of the fault tree FT. In one embodiment, the basic events BE represented, for example, by spherical bodies may include failure data. The failure data may include simulation data, sensor data and/or data input by the user. Other kinds of bodies for the different events may be used as well (e.g., tetraeders having four projection surfaces).

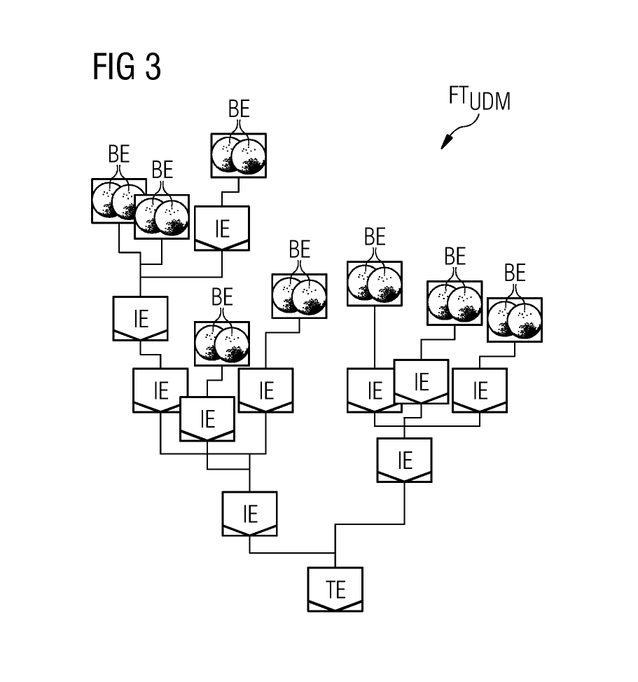

The engineering apparatus 1 illustrated in FIG. 1 may execute an engineering tool loaded by the engineering apparatus 1 from a database or a server. The engineering tool provides an operation interface displayed to the user by the graphical user interface 4. An exemplary implementation of a displayed operation interface of the engineering tool is illustrated in FIG. 2. The operation surface is partitioned, for example, in three areas. In a first area, a two-dimensional directory showing different hierarchical subsystems and levels of the fault tree FT may be shown to the user. In a second displayed area, an interactive three-dimensional mini-map 3DMM may be displayed to give the user an overview. The largest area displayed to the user includes an operation window displaying the three-dimensional fault tree FT to the user. In this window, the three-dimensional fault tree FT 3D-FT is displayed to the user in a nested or unfolded display mode. FIG. 3 shows an example of a three-dimensional fault tree FT displayed to the user via the graphical interface 4 including a top event TE at the bottom. The fault tree FT shown in FIG. 3 includes a plurality of levels L including basic levels of basic events BE represented by balls that are linked logically via levels L of intermediate events IE to the single top level event TE shown at the bottom of the displayed fault tree. The top event TE represents an undesired state of the investigated technical system. The top event TE forms the root of the illustrated three-dimensional fault tree FT. FIG. 3 shows the three-dimensional fault tree FT in the unfolded display mode, where all levels L of the fault tree FT are displayed simultaneously as an unfolded three-dimensional tree of interlinked events. Each of the intermediate events IE performs a logic combination of events of a lower level of the fault tree FT. This Boolean logic combination may include, for example, a logic AND or a logic OR combination. Other logic combinations may be used as well. The intermediate events IE are represented in the shown exemplary embodiment as cubus elements. In one embodiment, different events or elements may be displayed in different colors. For example, specific colors such as red may indicate critical events. Further, repeated events may be displayed in another color such as blue. Redundant basic events may be displayed in a corresponding specific color. For each event in the fault tree FT, an identification or name may be displayed. For each intermediate event IE represented by a cubus, a corresponding Boolean logic combination performed by the intermediate event may be displayed as well. The fault tree FT shown in FIG. 3 is a three-dimensional fault tree FT so that the user may virtually approach the three-dimensional tree and may, for example, circle around the three-dimensional fault tree FT illustrated in FIG. 3. In one embodiment, critical event paths in the fault tree FT may be displayed. Each event and the corresponding displayed three-dimensional body may include one or more attributes such as body form, body color and body volume. For example, the size or volume of the three-dimensional body may indicate the probability that the corresponding component or subsystem fails. Accordingly, if the three-dimensional body representing an event is large and has a high volume, the user may immediately understand that the corresponding event may be critical. The projection surfaces of the body are used as projection surfaces adapted to output analysis data such as simulation data, lifecycle curves or sensitivity analyzing data. The analyzing data may be linked via a database with technical three-dimensional drawings or models. In this way, the user may directly find system-critical components in the technical data model of the investigated system. During planning of the system, a user may describe the corresponding critical system component. For example, the user may reduce the criticality or improve the maintainability.

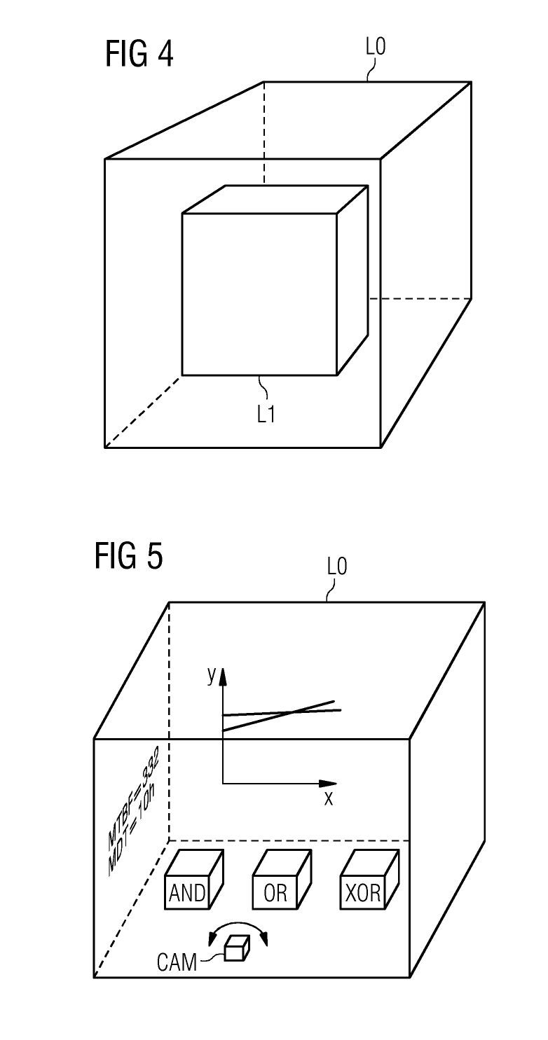

FIG. 4 illustrates how levels L of the fault tree FT are displayed in a nested display mode to the user. Each level L is represented by a cubus being nested in another cubus representing the next higher level of the fault tree FT. The cubus representing the top event or top level event TE is in the level L₀ of the fault tree FT into which one or several events of the next lower level L₁ may be nested. For example, the intermediate event IE may also be represented by a cubus, and a logic operation, as shown in FIG. 5, may be performed.

FIG. 5 shows a further example to illustrate the nested display mode. As shown, in the cubus representing level L₀, for example, three different three-dimensional bodies each also being formed by a cubus are nested to represent the next level of the fault tree FT. With a virtual camera, the user may approach the 3D virtual tree in the nested display mode and may dive into the fault tree FT by penetrating the outer cubus of level L₀. The virtual camera is placed within the inner volume of cubus L₀, and the three cubus “AND”, “OR” and “XOR” of the next level L₁ become visible, as illustrated in FIG. 5. Inner projection surfaces of cubus L₀ may be used as projection surfaces displaying analysis data of one or more events at the respective level to the user. In the shown example, six different projection surfaces of the outer cubus of level L₀ may be used for displaying analysis data to the user having dived by the virtual camera into the interior of the cubus of level L₀. In one embodiment, the virtual camera CAM illustrated in FIG. 5 may be moved within the interior of the outer cubus, and the perspective may change and be turned to one of the projection surfaces of the outer cubus. For example, a function diagram y(x) may be displayed to the user in the simple example of FIG. 5. On another projection surface, the user may see relevant information data such as Mean Time Between Failure MTBF. This data may include properties and/or attributes of Basic Events. In the displayed level, only results relevant for the respective level are shown. Input data of the basic events are only displayed at the basic event level. With the virtual camera CAM, the user has the option to dive into the fault tree FT starting from the highest level and, if desired, switch into an unfolded display mode as shown in FIG. 3. In the unfolded display mode, the user may circle around the three-dimensional fault tree FT or fly along a selected path of the three-dimensional fault tree FT. This path may be, for example, a critical path within the fault tree FT. The critical path may be shown to the user by three-dimensional bodies having specific attributes such as high volume, a highly visible color (e.g., red or yellow), or a specific form. Each event or subsystem may be identified by a name displayed on one of the projection surfaces of the cubus of the respective level. When diving through the three-dimensional fault tree FT through a plurality of levels L, the camera CAM will reach a level of basic events BE. The basic events BE may be illustrated by corresponding bodies such as cones or balls. An impact of a basic element BE of the system may also be represented by specific attributes of the body such as color or size. Further functions may be triggered interactively. For example, the projection surfaces of a cubus may be turned. Interactive inquiries may be provided (e.g., FMEA or spreadsheets). By turning the camera CAM virtually within the cubus of level L₀, as illustrated in FIG. 5, the perspective on the inner bodies representing intermediate events IE may change dynamically. The outer cubus may be turned around an axis so that a new projection surface including different types of analysis data becomes visible to the user.

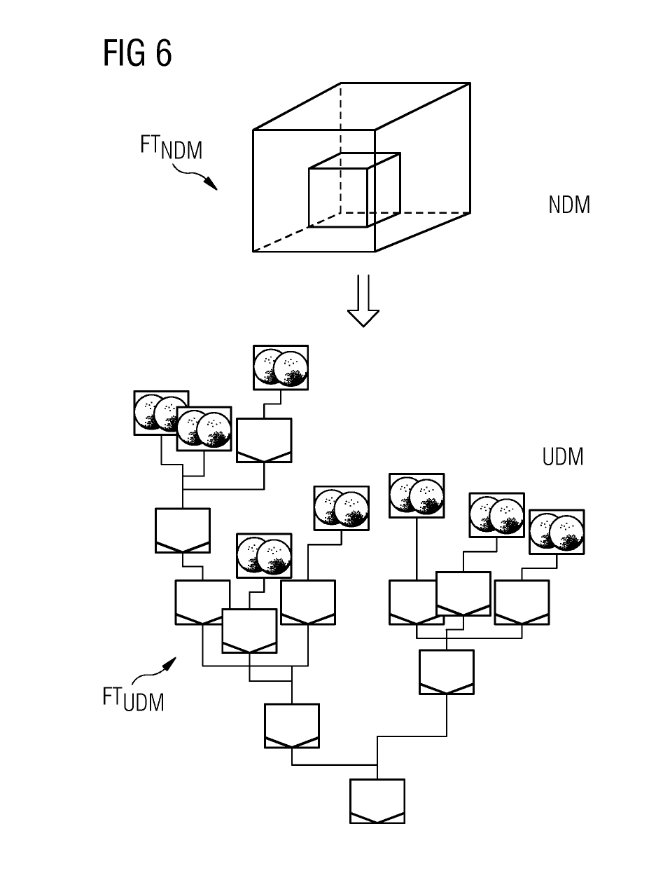

FIG. 6 shows the switching between a nested display mode NDM and the unfolded display mode UDM of the method and apparatus according to one or more of the present embodiments. For example, the user may zoom out until the top event TE is reached, and the initial outer cubus becomes visible. When activating the cubus such as clicking on the cubus, the fault tree FT is stepwise displayed in an unfolded display mode. The user may, for example, circle around the three-dimensional tree to approach specific events of interest. The user may, for example, dive into the cubus of an intermediate event IE to receive further analysis data. The user may fly along a critical path shown in the three-dimensional fault tree FT in the unfolded display mode UDM. The method according one or more embodiments provides a convenient and transparent way for performing a three-dimensional analysis of an investigated technical system. The investigated technical system may be a complex technical system including a plurality of interlinked components. The technical system may be, for example, a vehicle such as a car or an aircraft. In one embodiment, the investigated technical system displayed in the unfolded display mode UDM to the user, as illustrated in FIG. 3, may be displayed in an over-lay operation mode with a three-dimensional technical model such as a computer-aided design (CAD) model of the respective investigated technical system. In one exemplary implementation, the basic events BE of the fault tree FT may be interlinked with data models of the corresponding components of the investigated technical system. The basic events BE of the fault tree FT may represent faults of the corresponding components indicated by failure data. The investigated technical system may supply simulation data to the respective basic events. If a prototype of the investigated technical system exists, the basic events BE of the fault tree FT may also be provided at least partially by real sensor data received from sensors deployed in the prototype of the investigated technical system. In this embodiment, the engineering apparatus 1 shown in FIG. 1 may be connected via an interface to sensors within a prototype of the investigated technical system. Different display modes including the nested display mode and the unfolded display mode, as well as, in one embodiment, an over-lay display mode with a CAD model of the investigated system, allow the user to navigate easily within the three-dimensional fault tree FT. The plurality of projection surfaces offered by the three-dimensional bodies allows the user to look at a plurality of analysis data relevant for an event of interest without getting confused by the complexity of the investigated system. A complex technical system may be optimized taking into account optimized subsystems. In one embodiment, if the probability that an undesired top level event TE occurs exceeds a predetermined threshold, an alarm message may be generated. The method and engineering apparatus 1 according to one or more embodiments may be used for any kind of complex technical systems (e.g., trains, power plants, power supply systems, gas turbines or medical devices). On the basis of the output analysis data, the user may reconfigure the investigated system and/or may calculate maintenance time schedules for the planned investigated technical system. The method may further be used for hazard analysis and risk management.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for performing a three-dimensional analysis of an investigated technical system, the method comprising:
representing the investigated technical system with a corresponding fault tree having basic events linked logically to a top event of the investigated technical system, wherein the fault tree is a three-dimensional fault tree;
representing each event of the fault tree by a three-dimensional body having projection surfaces; and
outputting analysis data of the respective event to a user using the projection surfaces.

2. The method according to claim 1, wherein representing the investigated technical system comprises representing with the fault tree of the investigated technical system comprising a plurality of levels including a basic level of basic events linked logically via levels of intermediate events to a top level including a top event representing an undesired state of the investigated technical system.

3. The method according to claim 2, further comprising displaying the plurality of levels of the fault tree in a nested display mode to the user as nested in one another,
wherein each level of the plurality of levels is represented by a cubus being nested in another cubus representing a next higher level of the plurality of levels of the fault tree.

4. The method according to claim 2, further comprising displaying all levels of the plurality of levels of the fault tree in an unfolded display mode to a user as an unfolded three-dimensional tree of interlinked events.

5. The method according to claim 2, wherein the intermediate events perform a Boolean logic combination of events of a lower level of the plurality of levels of the fault tree.

6. The method according to claim 2, wherein representing the investigated technical system comprises representing with the basic events of the fault tree representing faults comprising failure data.

7. The method according to claim 1, wherein representing the investigated technical system comprises representing with the events of the fault tree representing technical components of the investigated technical system.

8. The method according to claim 4, wherein the events of the fault tree of the investigated technical system displayed in the unfolded display mode to the user are displayed within a three-dimensional model of the respective investigated technical system.

9. The method according to claim 6, further comprising providing the failure data of the basic events of the fault tree at least partially by simulation data received from a data model of the investigated technical system.

10. The method according to claim 6, further comprising providing the failure data of the basic events of the fault tree at least partially by sensor data received from sensors deployed in the investigated technical system.

11. An engineering apparatus adapted to perform a three-dimensional analysis of an investigated technical system, the engineering apparatus comprising:
a database that stores a constructed three-dimensional fault tree of the investigated technical system, the constructed three-dimensional fault tree having basic events linked logically to a top event of the investigated technical system; and
a calculation unit, wherein each event of the fault tree is represented by a three-dimensional body having projection surfaces each being adapted to display analysis data of the respective event calculated by the calculation unit on the basis of the stored fault tree to a user.

12. The engineering apparatus according to claim 11, wherein the fault tree of the investigated technical system stored in the database comprises a plurality of levels including a basic level of basic events linked logically via levels of intermediate events to a top level including a top event representing an undesired state of the investigated technical system.

13. The engineering apparatus according to claim 12, wherein the plurality of levels of the fault tree are displayable in a nested display mode to the user as nested in one another, wherein each level of the plurality of levels is represented by a cubus being nested in another cubus representing a next higher level of the plurality of levels of the fault tree, or
wherein all levels of the plurality of levels of the fault tree are displayable simultaneously in an unfolded display mode to the user as an unfolded three-dimensional tree of interlinked events.

14. The engineering apparatus according to claim 12, wherein the basic events of the fault tree represent faults comprising failure data, and
wherein the failure data of the basic events of the fault tree is provided at least partially by simulation data received from a data model of the investigated technical system, or
the failure data of the basic events of the fault tree is provided at least partially by sensor data received from sensors deployed in the investigated technical system.

15. The engineering apparatus according to claim 13, wherein all levels of the plurality of levels of the fault tree are displayable simultaneously in an unfolded display mode to the user as an unfolded three-dimensional tree of interlinked events, and
wherein the events of the fault tree of the investigated technical system displayed in the unfolded display mode to the user are displayed within a three-dimensional model of the respective investigated technical system.

16. In a non-transitory computer readable storage medium having program code including instructions executable by one or more processors to perform a three-dimensional analysis of an investigated technical system, the instructions comprising:
representing the investigated technical system with a corresponding fault tree having basic events linked logically to a top event of the investigated technical system, wherein the fault tree is a three-dimensional fault tree;
representing each even of the fault tree by a three-dimensional body having projection surfaces; and
outputting analysis data of the respective event to a user using the projection surfaces.

17. The non-transitory computer readable storage medium according to claim 16, wherein representing the investigated technical system comprises representing with the fault tree of the investigated technical system comprising a plurality of levels including a basic level of basic events linked logically via levels of intermediate events to a top level including a top event representing an undesired state of the investigated technical system.

18. The non-transitory computer readable storage medium according to claim 17, wherein the instructions further comprise displaying the plurality of levels of the fault tree in a nested display mode to the user as nested in one another,
wherein each level of the plurality of levels is represented by a cubus being nested in another cubus representing a next higher level of the plurality of levels of the fault tree.

19. The non-transitory computer readable storage medium according to claim 17, wherein the instructions further comprise displaying all levels of the plurality of levels of the fault tree in an unfolded display mode to a user as an unfolded three-dimensional tree of interlinked events.

20. The non-transitory computer readable storage medium according to claim 17, wherein the intermediate events perform a Boolean logic combination of events of a lower level of the plurality of levels of the fault tree.
